(19) United States
(12) Patent Application Publication
(10) Pub. No.: US 2004/0198205 A1
(43) Pub. Date: Oct. 7, 2004

(54) Grinding stone with lubrication particles and manufacturing method thereof

(75) Inventors: Shinji Soma, Handa-shi (JP); Tomoyuki Kasuga, Kariya-shi (JP); Takayuki Yoshimi, Toyohashi-shi (JP); Hiroshi Morita, Hoi-gun (JP); Hideki Tamashima, Nagoya-shi (JP); Satoshi Okubo, Anjo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYODA KOKI KABUSHIKI KAISHA, Kariya-shi (JP)

(21) Appl. No.: 10/737,854

(22) Filed: Dec. 18, 2003

(30) Foreign Application Priority Data
Mar. 26, 2003 (JP) 2003-084674

(51) Int. Cl. C09C 1/68; B24D 3/02

(52) U.S. Cl. 451/540; 51/307

(57) ABSTRACT

A solid fats and oils is impregnated in an air space of a stone matrix, as lubrication particles, of a grinding stone. The fats and oils is melted out of the air space to a peripheral surface of the grinding stone to lubricate friction between the grinding stone and a workpiece and to create a space again in the air space of the stone matrix. The created space can perform to receive a cutting tip and to discharge it. The melted lubrication particles lubricate friction between the grinding stone and the workpiece to restrain a generation of heat in order to reduce a grinding resistance. As a result, it restrains a loss of grinding particles on the peripheral surface of the grinding stone to keep a high quality of the grinding characteristics of the workpiece and to extend a truing interval and a life of the grinding stone.

The present application claims priority under 35 U.S.C. §119 to Japanese Patent Application No. 2003-084674, filed on Mar. 26, 2003. The content of that application is incorporated herein by reference in their entirety.

### BACKGROUND OF THE INVENTOIN

1. Field of the Invention

The present invention relates to a grinding stone for grinding, especially a grinding stone with lubrication particles.

2. Description of the Related Art

It is typically known for a grinding in a mass production to supply a massive amount of coolant such as 100 to 150 liters per minute to a grinding point contacting a grinding wheel with a workpiece. In order to prevent an environmental contamination or to reduce a cost of an exhausted coolant process for energy saving, a semi-dry grinding using a small amount of coolant becomes in goods, the semi-dry grinding is disclosed in U.S. Pat. No. 6,305,183 (a related European Patent Application 0 985 490 A3) assigned to this applicant. This semi-dry grinding supplies a small amount of lubrication fluid of vegetable oil and so on to a peripheral surface of the grinding wheel at an upper stream from the grinding point and the small amount of coolant, that is to say 1/20 (one twentieth) of that of the well known grinding, to the workpiece for cooling. In this semi-dry grinding, the lubrication for the grinding point and the cooling of the workpiece is separated each other and a generation of heat at the grinding point is not cooled by the coolant but a generation of friction heat by contacting the grinding wheel with the workpiece is restrained by lubrication function of the lubrication fluid. The reason is that the lubrication fluid restrains an increasing of grinding resistance so that the friction heat generated by the grinding resistance is also restrained by the lubrication fluid. There are two types of the semi-dry grinding, one is to supply a small amount of lubrication fluid such as the vegetable oil with air at the peripheral surface of the grinding wheel and the other is to supply the small amount of the coolant to a peripheral surface of the workpiece. These semi-dry grindings supply one of the lubrication fluid and the coolant to a grinding area but it is better to supply the lubrication fluid from the grinding wheel itself without supplying from out of the grinding wheel in order to prevent the lubrication oil from scattering. The grinding wheel with such lubrication function can be used for a dry grinding.

The grinding wheel with lubrication function for such a dry grinding is disclosed in the Japanese Laid-open publication No. 11-188635. This related prior art discloses a grinding wheel has an air space between grinding particles and bonds and a fatty acid salt impregnated on a surface of the space. The fatty acid salt has a melting point of more than 100° C. to be melted by a friction heat at the grinding point and to lubricate there. However, the grinding wheel with the lubrication function is manufactured by melting the solid fatty acid salt in a natural temperature by water and a solvent such as an ethyl alcohol, dipping the grinding wheel into the liquid fatty acid salt and impregnating its into the grinding wheel. A salt base of the fatty acid salt is consisted of an alkali metal such as sodium (Na⁺), an alkaline earth metal such as calcium (Ca⁺), or a metallic soap such as zinc (Zn²⁺). An alkaline component of the fatty acid salt remains in a grinding machine or the workpiece to corrode the workpiece, to cause the environmental contamination, or to be scattered and accumulated on the grinding machine to damage it. The grinding wheel with the lubrication function of the related art is to have a purpose to be used for the dry grinding without using any lubrication nor coolant and the melting point of the impregnated fatty acid salt is high as more 100° C. Since there is no lubrication nor cooling function by the lubrication oil or the coolant, generated heat at the grinding point is transferred into not only the peripheral surface layer but also a deep area of the grinding wheel so that the melting of the fatty acid salt is occurred in the peripheral surface layer and a next peripheral surface layer after truing. Therefore, the grinding wheel with the lubrication function of the related art is respected to make a substantial good result for the lubrication in the dry grinding.

However, the grinding wheel with the lubrication function of the related art can not achieved the substantial good result in the semi-dry grinding. A temperature at the grinding point in the semi-dry grinding does not increase to the temperature made by the dry grinding. Therefore, the grinding wheel with the lubrication function of the related art has a high melting point such as more 100° C. of the lubrication particles so that a melting amount of the fatty acid salt is not enough and an enough lubrication effect can not be respected. The reason is that the fatty acid salt in the peripheral surface layer of the grinding wheel with the lubrication function of the related art is melted enough at the peripheral surface layer but the fatty acid salt in the next peripheral surface layer is not melted enough in the semi-dry grinding so that the melted fatty acid salt in the peripheral surface layer becomes to be lost according to an increase of the grinding material removal amount to decrease the lubrication function.

### SUMMARY OF THE INVENTION

In view of the previously mentioned circumstances, it is an object of the present invention to provide a grinding stone with lubrication particles having an enough lubrication result with no damage of a grinding machine, no corrosion of a workpiece and no environmental contamination in a relatively low temperature grinding.

It is second object of the present invention to provide a grinding stone with lubrication particles having an enough lubrication result in a semi-dry grinding.

It is third object of the present invention to provide a grinding stone with lubrication particles having no damage of a grinding machine and no corrosion of a workpiece without using a fatty acid salt.

It is fourth object of the present invention to provide a grinding stone with lubrication particles reducing a manufacturing cost by using a cheap stearic acid.

It is fifth object of the present invention to provide a grinding stone with lubrication particles having high grinding performance and large lubrication function by using CBN particles and a vitrified bond.

It is another object of the present invention to provide a manufacturing method of a grinding stone with lubrication particles having stable lubrication function.

It is other object of the present invention to provide a manufacturing method of a grinding stone with lubrication particles reducing a manufacturing cost by using a cheap stearic acid.

In order to achieve the above and other objects, the present invention provides a grinding stone with lubrication particles having a stone matrix with an air space between plural grinding particles, the lubrication particles are fats and oils having a melting point of 60° C. to 130° C. impregnated and filled in the air space in a solid state for lubrication. The solid fats and oils impregnated in the air space of the stone matrix is melted to the peripheral surface of the grinding stone to lubricate thereof and makes a space again to be able to receive grinding tips therein and to discharge them. At this time, the melted lubrication particles are to decrease friction between the grinding particles and the workpiece at the grinding point and to restrain a generation of heat and therefore to reduce a grinding resistance so that it can prevent the grinding particles from being removed and restrains damage of the grinding stone and also, it can extend a truing interval of the grinding stone to contribute to a long wheel life. Especially, since the melting point of the fats and oils impregnated in the air space of the stone matrix is more than 60° C., the grinding stone with the lubrication particles can be adopted for a grinding with a small temperature increase at the grinding point.

Second aspect of the present invention is that the grinding stone with lubrication particles explained in above first aspect of the present invention is used for a semidry grinding method consisting of relatively moving the rotating grinding stone and the rotating workpiece to grind the workpiece, and feeding a small amount of at least one of lubrication fluid or coolant to the grinding point. In the semi-dry grinding, a small amount of at least one of the lubrication fluid and the coolant is supplied to a grinding area to restrain the generating heat at the grinding point. Where the grinding particle is a CBN particle, at a time that the large heat is generated at the grinding point by a dull sharpness of the cutting edge of the grinding particles just after truing, enough lubrication function is performed by melting the solid fats and oils from the air space of the stone matrix of the peripheral surface layer of the grinding stone and from the next peripheral surface layer. And also, at a high sharpness of the cutting edge of the grinding particles after a grinding material removal amount, that is to say a number of ground workpiece is increased, the remaining solid fats and oils is melted to maintain lubrication function of the peripheral surface of the grinding stone. Therefore, the grinding stone with lubrication particles has a good lubrication function especially in semi-dry grinding.

Third aspect of the present invention is that the fats and oils is a saturated fatty acid with a melting point of 60° C. to 100° C. The saturated fatty acid is melted by heat to be impregnated into the air space of the stone matrix. Therefore, the grinding stone with lubrication particles of the present invention does not use an alkali metal, an alkaline earth metal nor a metallic soap, so that it does not damage the grinding machine nor corrode the workpiece.

Fourth aspect of the present invention is that the fats and oils is a fatty acid with a melting point about 70° C. such as a stearic acid. Since the stearic acid is got easily in a cheap cost as the industrial fats and oils so that the manufacturing cost of the grinding stone is reduced.

Fifth aspect of the present invention is that the grinding particle is a CBN particle and the bond is a vitrified bond. The CBN particles performs a high intensive grinding and the vitrified bond has a large space of the stone matrix to be impregnated a large volume of the solid fats and oils so that it can present the grinding stone with the high grinding performance and the large lubrication function.

Sixth aspect of the present invention is a manufacturing method of a grinding stone with lubrication particles defines in the first aspect of the present invention. Since in the manufacturing method of this invention, pressure or a vibration in the container is supplied to suck air in the air space and fill the liquid fats and oils in the air space of the stone matrix, it can impregnate the fats and oils in the air space of a deep place of the stone matrix to stable of the lubrication function in all of a wheel life.

Seventh aspect of the present invention is a manufacturing method of a grinding stone with lubrication particles that the fats and oils is a fatty acid with a melting point about 70° C. such as a stearic acid. Since the stearic acid is got easily in a cheap cost as the industrial fats and oils so that the manufacturing cost of the grinding stone is reduced.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a schematic view of the grinding stone with lubrication particles according to the present invention;

FIG. 2 is a partially enlarged cross-sectional view of the stone matrix of the grinding stone with lubrication particles in FIG. 1;

FIG. 3 is a chart of showing the melting point of the fats and oils such as the fatty acid as the solid lubrication particle;

FIG. 4 is an explanatory diagram of a vacuum impregnating of the fats and oils into the grinding stone;

FIG. 5 is an explanatory diagram of the semi-dry grinding;

FIG. 6 is a graph showing results of the grindings by the grinding stone of the present invention, the grinding stone of the related art and the normal grinding stone.

### DETAILED DESCRIPTION OF THE PREFERRED EMBODIMENTS

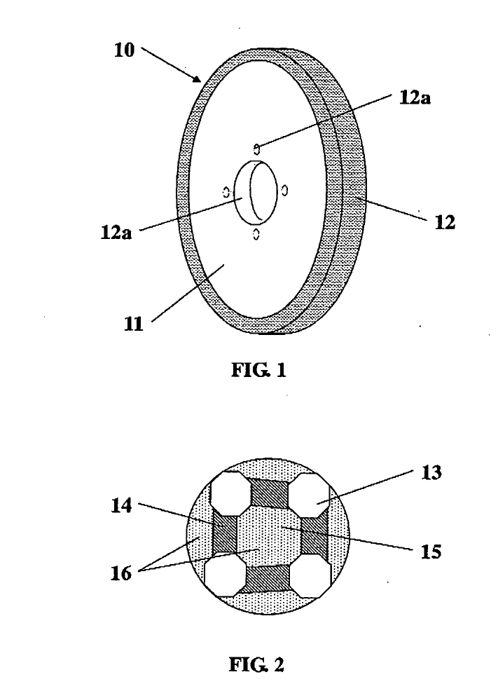

A preferred embodiment of the grinding stone with lubrication particles according to the present invention will be described referring to FIG. 1 to FIG. 3. In FIG. 1 and FIG. 2, a numeral 10 shows a grinding wheel with lubrication particles, the grinding wheel 10 comprises a disk-like wheel base 11 and a ling-like stone layer 12 secured on a peripheral surface of the wheel base 11 by a suitable bond or by baking. The wheel base 11 consists of metallic materials from a steel, an aluminum or a titanium or consists of a FRP (Fiber-Reinforced Plastic). The stone layer 12 is manufactured by securing a grinding stone ling baked to a ling-like form or by bonding a plurality of grinding stone segments to the ling-like form. A center hole 12a is formed in a center of the wheel base 11, through which a boss projected from a shaft end of a wheel spindle is penetrated in a tight manner. Plural bolt bores 12b are formed out of the center hole 12a on the wheel base 11, through which a bolt screwed into the shaft end is inserted so that the bolts are inserted into the bolt bores 12b to be screwed into the wheel shaft in order to fix the grinding wheel 10 on the wheel shaft.

FIG. 2 is an enlarged view of an organization of the stone layer 12. The stone layer 12 is manufactured by mixing, forming and baking plural grinding particles 13 and liquid vitrified bond to combine grinding particles 13 each other in a bridge by the baked solid vitrified bond. The grinding particle 13 consists of one of a CBN (Cubic Boron Nitride) particle, a diamond particle, an Aluminum oxide particle, a silicon carbide particle or other grinding particle, or mixed thereof. The embodiment of the present invention uses the CBN particle. It can be used a mullite as a filler to reduce a concentration of the grinding particle, a particle size of the mullite is similar to a size of the CBN particle. When the bond 14 becomes a solid to combine the CBN particles 13 each other in the bridge, it creates an air space 15 holding and discharging a cut tip in and from the air space 15 to constitute a grinding stone matrix, Fats and oils 16 as a solid lubrication particle is fixed on an inside surface of the air space 15 to produce the grinding wheel 10 with the solid lubrication particles, and said fats and oils 16 is the solid in a normal temperature like about 20° C. and has a melting point of 60° C. to 130° C. The fats and oils 16 is selected from a fatty acid or a fatty acid amid. The fatty acid is a saturated fatty acid that is, for example, a stearic acid or a palmitic acid. The fatty acid amid is a stearic acid, for example. These fats and oils 16 are stable as the solid in the normal temperature and have the melting point of 60° C. to 130° C.

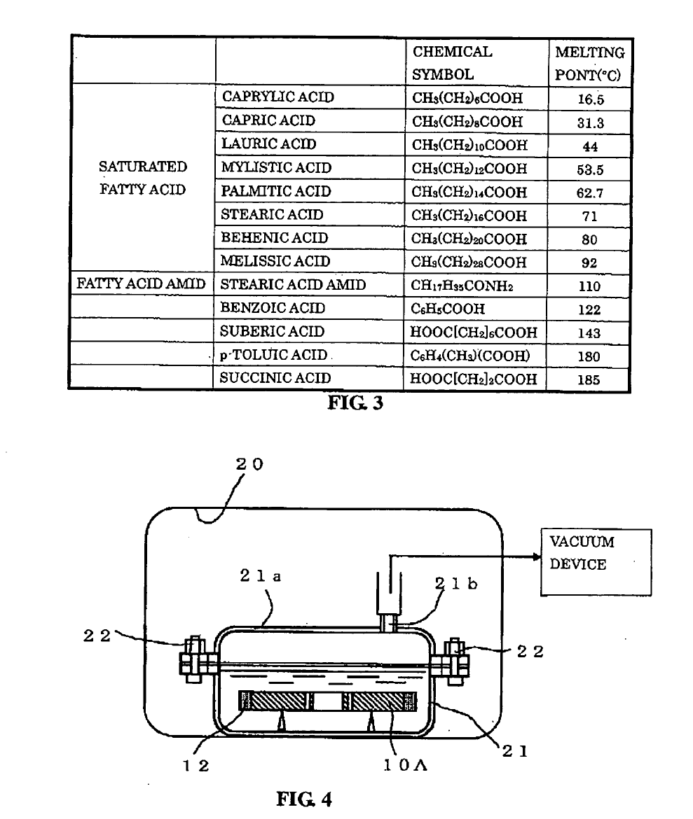

Next one embodiment of the manufacturing method of the grinding stone with the lubrication particles according to the present invention will be described hereinafter. First of all, the CBN stone layer 12 is produced by a well known method. According to the well known method producing a normal grinding wheel before impregnating the lubrication particles, the CBN grinding particles 13 and the liquid vitrified bond 14 are mixed and thereafter, they are filled into an unillustrated molding flask having an air space referring to the ling-like stone layer 12 or each of segments of plural grinding stones and then pressed and formed. The formed stone layer 12 or its segments are removed from the molding flask and then baked at approximately 900° C. for a few hours to fix the vitrified bond 14. Thereafter, it is cooled at the natural temperature. The grinding stone or its segments are bonded on the peripheral surface of the wheel base 11 to be secured in order to manufacture the grinding wheel 10A before impregnating the lubrication particles. The numeral 10A shows the grinding wheel before impregnating in FIG. 4. FIG. 4 shows an impregnating process of the lubrication particles into the grinding wheel 10A in vacuum. The lubrication particles are fats and oils which are solid in the natural temperature shown in FIG. 3, and a stearic acid 16 from a saturated fats acid is selected as the lubrication particles in this one embodiment of the present invention. The stearic acid 16 is solid and heated to be melted in a container 21. The grinding wheel 10A is dipped in the liquid of the stearic acid 16 and a cover 21A is fixed on the container 21 by a fastener 22 to close tightly from an atmosphere. A vacuum device 23 is connected to an absorbing inlet 21b to absorb air from the container 21 in order to make vacuum. Therefore, the air in the space 15 of the stone matrix of the wheel stone 12 in the grinding wheel 10A is absorbed from the container 21 to the atmosphere so that the stearic acid 16 is filled up in the air space 15 of the stone matrix instead of the air. In same time, the stearic acid 16 accumulates on the surfaces of the grinding particle 13 and the solid bond 14. The grinding wheel 10A with the lubrication particles is removed from liquid of the stearic acid 16 of the container 12. After the removing, the liquid of the stearic acid 16 remains in the air space 15 by viscosity and surface tension thereof. The grinding wheel 10A is dried in the natural temperature to be the grinding wheel 10 shown in FIG. 1 with the organization of the stone matrix of the grinding particle 13 with the solid lubrication particle 16 shown in FIG. 2. In the grinding stone matrix of the grinding wheel 10, the stearic acid 16 is solid on the surfaces of the grinding particles 13 and the bond 14 and filled up in the air space 15.

In the present invention, since the lubrication particle is the fats and oils such as the saturated fatty acid or the fatty acid amid which is solid in the natural temperature but liquid to be melted by heat, the lubrication particles can be solid easily by cooling after impregnating into the stone matrix of the grinding wheel 10. Since said related art has to melt the fatty acid salt by the solvent and sinter the liquid fatty acid salt into the matrix of the grinding particles, it has the trouble that an alkaline component of the solvent remains in the grinding wheel to affect in removing in a grinding machine after grinding thereby to damage parts of the grinding machine by chemical reaction or to be discharged with a grinding tip in a coolant out of the grinding machine to cause an environmental contamination. On the other hand, the present invention does not have these troubles by using the lubrication particles which are melt by heat and are solid in the natural temperature without using the solvent. And also since the solvent of the grinding wheel with the lubrication particles of said related art is vaporized by drying after impregnating, it creates a space so that the air space 15 is not filled up by the lubrication particles in one impregnating process to repeat impregnating process two or three times more. On the other hand, because the present invention does not use the solvent, the fats and oils 16 such as the saturated fatty acid or the fatty acid amid is filled up the air space 16 of the stone matrix of the grinding wheel 10 so that the manufacturing process is simple and short.

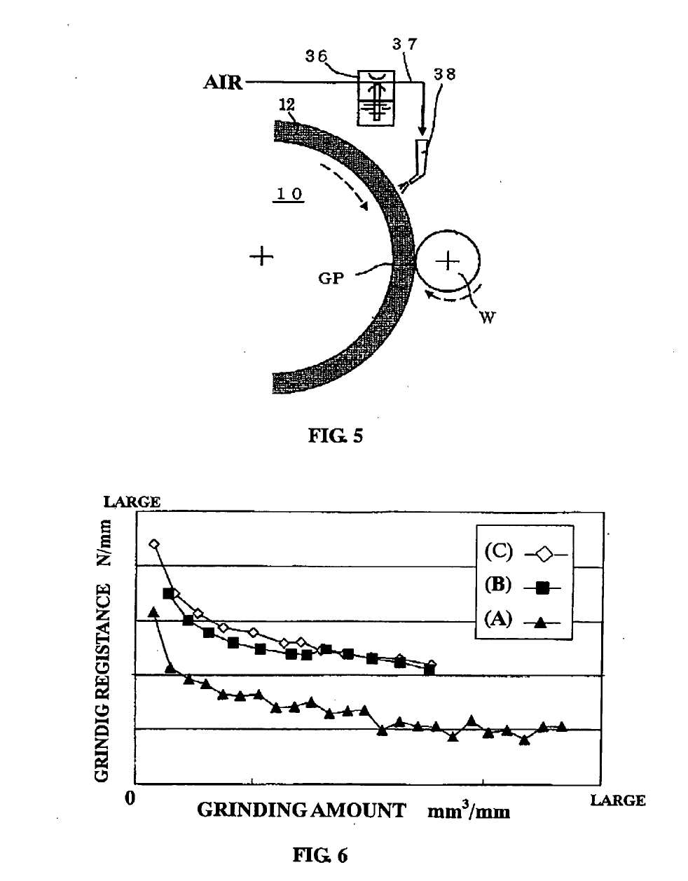

Next one embodiment of the grinding wheel with the lubrication particles for the semi-dry grinding according to the present invention will be described hereinafter. FIG. 5 discloses a semi-dry grinding by the grinding wheel 10 with lubrication particles. Vegetable oil is reserved in a mist generation device 36 and compressed air sucks the vegetable oil to mix the air into the mist. A small amount of the oil mist is fed to a nozzle 38 through a pipe 37 to be blown to the grinding wheel 10 at an upper stream point from a grinding point GP for lubrication function. A doted arrow line in FIG. 5 shows each rotational direction of the grinding wheel 10 and a workpiece W. The grinding wheel 10 of the present invention grinds the workpiece W under next conditions. During the semi-dry grinding, the oil mist from the nozzle 38 cools a friction heat generated by contacting the grinding wheel 10 with the workpiece W and also lubricates the grinding point so that melted lubrication particles 16 from the air space 15 of the grinding wheel 10 can lubricate directly the grinding point GP to maintain a low grinding resistance with a cooperation of the mist oil, these are experimentally certified hereinafter by FIG. 6. For comparison with the grinding wheel (A) of the present invention, a grinding wheel (B) of the related art and a well known normal grinding wheel (C) with next conditions grind the workpiece W.

Grinding Conditions:

Grinding wheel; Vitrified CBN grinding wheel with 350 mm diameter and 20 mm width.

The grinding wheel (A) of the present invention: with the stearic acid of 71° C. of the melting point.

The grinding wheel (B): with the fatty acid salt of 40° C. of the melting point.

The grinding wheel (C): without the fats and oils.

Grinding surface speed; 80 meter per second.

Workpiece material; a hardened chromium-molybdenum steel.

Grinding method; a cylindrical plunge grinding.

Removal amount; 0.3 mm in diameter.

Lubrication; the oil mist of 20 ml (milliliter) for the semi-dry grinding.

FIG. 6 shows a relationship between a workpiece grinding metal removal amount and a grinding resistance in results of these grindings. FIG. 6 discloses as a result that the grinding resistance by the grinding wheel (A) of the present invention is decreased about 30% compared to the normal grinding wheel (C) so that the present invention does not have the trouble increasing the grinding resistance according to the increase of the grinding metal removal amount in the related art On the other hand, the result of the grinding resistance by the grinding wheel (B) shows a decrease compared to the normal grinding wheel (C) in a very beginning of the grinding just after truing, however in accordance with an increase of the grinding metal removal amount, the decrease of the grinding resistance is small to approach to the result by the normal grinding wheel (C). The reason of this result is that the typical characteristic of the CBN grinding wheel has a high temperature at the grinding point GP just after truing to melt a large amount of fatty acid salt from the surface layer of the grinding wheel 10 so that the amount of melting fatty acid salt is decreased according to the continuing grinding, that is to say the increase of the grinding metal removal amount, therefore, to raise a missing of the substantial amount of the fatty acid salt for the lubrication at the surface of the grinding wheel 10.

Therefore, it is needed for the fats and oils in the stone matrix of the grinding wheel that the melting point thereof is more than 60° C. In the semi-dry grinding, an increase of the temperature at the grinding point GP is restrained by a supply of th oil mist cooling the grinding point GP so that the grinding wheel with more 130° C. of the melting point can not melt enough amount of the solid lubrication particles to lack the lubrication. As a result, the melting point of the fats and oils 16 included in the grinding wheel 10 of the present invention is more than 60° C. and not more than 130° C. in the semi-dry grinding. The fats and oils satisfying this temperature limit is selected from a palmitic acid, a stearic acid, a behenic acid, melissic acid, stearic acid amid and benzoic acid in FIG. 3. The grinding wheel with these fatty acids shows the same result to the grinding wheel (A) in FIG. 6. Besides, the melting point of the best fats and oils 16 is around 70° C. such as the stearic acid and 70 to 110° C. of the melting point such as the stearic acid, the behenic acid, the melissic acid and the stearic acid amid can achieve the better result in the semi-dry grinding.

The grinding wheel 10 with the solid fats and oils 16 in the natural temperature having the melting point of these temperature limits is good for the semi-dry grinding because of the cooperation of the lubrication by the mist oil and the lubrication particles. It performs the large amount of grinding with the small amount of the grinding resistance in the grinding of small amount of the temperature generated at the grinding point GP so that it restrains the grinding resistance of the grinding wheel 10 from the truing to the next truing. Therefore, it decreases a power loss of a driving motor for the grinding wheel and a material characteristic of the ground surface of the workpiece W is maintain in a high quality so that a truing interval or a grinding wheel life is increase.

While the invention has been described in detail with reference to the preferred embodiment, it will be apparent to those skilled in the art that the invention is not limited to the present embodiment, and that the invention may be realized in various other embodiments within the scope of the claims.

For example, the present invention is explained these embodiments that the grinding stone is the grinding wheel like the disk wheel shape but it can be formed like a rectangular shape or other shape.

And also, the present invention is explained these embodiments that the fats and oils 16 is impregnated after the stone layer 12 is bonded on the wheel base 11 but it is applicable that the impregnating process of the fats and oils can be performed before the stone layer 12 is bonded on the wheel base 11.,

In the above-mentioned embodiments, the impregnating is performed by the vacuum method, however, it can be performed by a pressure introducing method or a vibration method. The pressure introducing method is performed by a method that after the stone layer 12 is placed at a boundary between a high and a low pressure rooms the melted fats and oils 16 is fed through the stone layer 12.

In the above-mentioned embodiments, the grinding wheel 10 with lubrication particles of the present invention is introduced in the cylindrical grinding machine, however it can be introduced in a plane grinding, an end surface grinding, a cam grinding, a screw thread grinding and so on.

In the above-mentioned embodiments, the semi-dry grinding performs by blowing the small amount of the oil mist against the peripheral surface of the grinding wheel by the compressed air for lubrication but it can be added a small amount of a coolant to the peripheral surface of the workpiece for cooling. It can be performed by only supplying the coolant to the peripheral surface of the workpiece.

The grinding stone with lubrication particles of the present invention can be applicable to a dry grinding in a condition of restraining the increase of the temperature at the grinding point.

Furthermore, the technological components described in this specification and illustrated in the drawings can demonstrate their technological usefulness independently through various other combinations which are not limited to the combinations described in the claims made at the time of application. Moreover, the art described in this specification and illustrated in the drawings can simultaneously achieve a plurality of objectives, and is technologically useful by virtue of realizing any one of these objectives.

What is claimed is:

1. A grinding stone with lubrication particles comprising:
a stone matrix consisting of a plurality of grinding particles;
a bond combining said grinding particles each other; and
an air space between said grinding particles, wherein
said lubrication particles are fats and oils having a melting point of 60° C. to 130° C.; and
said fats and oils are impregnated and filled in said air space in a solid state for lubrication.

2. A grinding stone with lubrication particles for a semidry grinding method consisting of relatively moving a grinding stone and a workpiece to grind said workpiece, and feeding a small amount of at least one of lubrication fluid or coolant to a grinding point, wherein
said grinding stone has a stone matrix consisting of a plurality of grinding particles, a bond combining said grinding particles each other, and an air space between said grinding particles;
said lubrication particles are fats and oils having a melting point of 60° C. to 130° C.; and
said fats and oils are impregnated and filled in said air space in a solid state for a lubrication.

3. A grinding stone with lubrication particles according to one of claim 1 and claim 2, said fats and oils is a saturated fatty acid with a melting point of 60° C. to 100° C.

4. A grinding stone with lubrication particles according to claim 3, said fatty acid has a melting point about 70° C. such as a stearic acid.

5. A grinding stone with lubrication particles according to claim 4, said grinding particle is a CBN particle and said bond is a vitrified bond.

6. A grinding wheel with lubrication means comprising:
a wheel matrix means consisting of a plurality of grinding particles;
a bonding means combining said grinding particles each other; and
an air space means between said grinding particles, wherein
said lubrication means are a stearic acid having a melting point of about 70° C.; and
said stearic acid are impregnated and filled in said air space means in a solid state for lubrication.

7. A manufacturing method of a grinding stone with lubrication particles having a stone matrix consisting of a plurality of grinding particles bonded each other by a bond, and an air space between grinding particles, said grinding stone further having fats and oils impregnated and filled in said air space as a lubrication particles, said manufacturing method comprising:
heating and melting said solid fats and oils with a melting point of 60° C. to 130° C. to a liquid fats and oils in a container;
dipping said grinding stone without lubrication particles in said liquid fats and oils;
applying pressure or a vibration in said container to suck air in said air space and fill said liquid fats and oils in said air space;
removing said grinding stone from said container to dry to a natural temperature, thereby to fill said solid fats and oils in the air space of said stone matrix.

8. A manufacturing method of a grinding stone with lubrication particles according to claim 6, said solid fats and oils is a fatty acid.
